(19) United States
(12) Patent Application Publication
(10) Pub. No.: US 2012/0140114 A1
(43) Pub. Date: Jun. 7, 2012

(54) HOUSING STRUCTURE AND IMAGING DEVICE

(75) Inventor: Hiroshi YAMAURA, Osaka (JP)

(73) Assignee: Panasonic Corporation, Osaka (JP)

(21) Appl. No.: 13/050,890

(22) Filed: Mar. 17, 2011

(30) Foreign Application Priority Data
Dec. 2, 2010 (JP) 2010-269520

(51) Int. Cl. H04N 5/225; G03B 17/02

(52) U.S. Cl. 348/373; 396/535; 348/E05.024

(57) ABSTRACT

A housing structure comprises a housing and a built-in member. The housing includes a first cover having a first inner surface and a second cover having a second inner surface. The first cover abuts the second cover and defines a gap through which the first inner surface is configured to communicate with the second inner surface. The built-in member is formed in the housing and includes an opposing surface and a reflecting component. The opposing surface is disposed opposite to the first inner surface and the second inner surface, and the reflecting component includes an inclined surface that faces the gap. The inclined face is disposed at an angle relative to the opposing surface.

### CROSS-REFERENCE TO RELATED APPLICATIONS

This application claims priority under 35 U.S.C. §119 to Japanese Patent Application No. 2010-269520, filed on Dec. 2, 2010. The entire disclosures of Japanese Patent Applications No. 2010-269520 is hereby incorporated herein by reference.

### BACKGROUND

1. Technical Field

The technology disclosed herein relates to a housing structure comprising a housing made up of a plurality of covers and, more particularly, to an imaging device comprising the aforementioned housing structure.

2. Background Information

An imaging device is known in the past which comprised a housing made up of a first cover and a second cover butted against the first cover, and a leg seat that is disposed inside the housing and is opposite a boundary between the first cover and second cover (see Japanese Laid-Open Patent Application JP2007-3648, for example). With the imaging device discussed in JP2007-3648, the leg seat has an opposing face that is opposite a first inner face of the first cover and a second inner face of the second cover.

With the imaging device discussed in JP2007-3648, however, if there is a gap at the boundary between the first cover and the second cover, the leg seat ends up being visible through the gap from the outside of the housing. More specifically, light coming into the interior of the housing through the gap is reflected by the opposing face of the leg seat and ends up going back outside the housing through the gap. This is a problem in that it diminishes the aesthetic quality of the imaging device.

### SUMMARY

The technology disclosed herein is conceived in light of the above situation, and it is an object thereof to provide a housing structure and an imaging device in which the aesthetic quality can be improved.

In accordance with one aspect of the technology disclosed herein, a housing structure is provided that comprises a housing and a built-in member. The housing includes a first cover having a first inner surface and a second cover having a second inner surface. The first cover abuts the second cover and defines a gap through which the first inner surface is configured to communicate with the second inner surface. The built-in member is formed in the housing and includes an opposing surface and a reflecting component. The opposing surface is disposed opposite to the first inner surface and the second inner surface, and the reflecting component includes an inclined surface that faces the gap. The inclined face is disposed at an angle relative to the opposing surface.

These and other objects, features, aspects and advantages of the present invention will become apparent to those skilled in the art from the following detailed description, which, taken in conjunction with the annexed drawings, discloses embodiments of the present invention.

### BRIEF DESCRIPTION OF DRAWINGS

Referring now to the attached drawings which form a part of this original disclosure:

FIG. 1 is an oblique view of a digital camera;

FIG. 2 is an exploded oblique view of the digital camera;

FIG. 3 is a bottom view of the digital camera;

FIG. 4 is an oblique view of a first frame, as seen from an back face side;

FIG. 5 is an oblique view of the first frame, as seen from the opposing face side;

FIG. 6 is a cross section along the IV-IV line in FIG. 3;

FIG. 7 is a detail enlargement of FIG. 3;

FIG. 8 is a cross section showing the configuration of the first frame (another embodiment);

FIG. 9 is a cross section showing the configuration of the first frame (another embodiment);

FIG. 10 is a cross section showing the configuration of the first frame (another embodiment);

FIG. 11 is a cross section showing the configuration of the first frame (another embodiment); and

FIG. 12 is a cross section showing the configuration of the first frame (another embodiment).

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

In the description of the drawings below, those components that are the same or similar will be given the same or similar numbers. The drawings are merely schematic, however, and the dimensional proportions may in some cases differ from those in actuality. Therefore, the specific dimensions and so forth should be determined by reference to the description that follows. Also, portions whose dimensional relationship or proportions vary from one drawing to the next may of course be included.

In the following embodiments, a digital camera will be used as an example in describing an imaging device. In the following description, the following positional terms “front”, “rear”, “up”, “down”, “right”, and “left” are used with reference to a digital camera in its normal orientation to the subject (hereinafter also referred to as landscape orientation).

Overall Configuration of Digital Camera 100

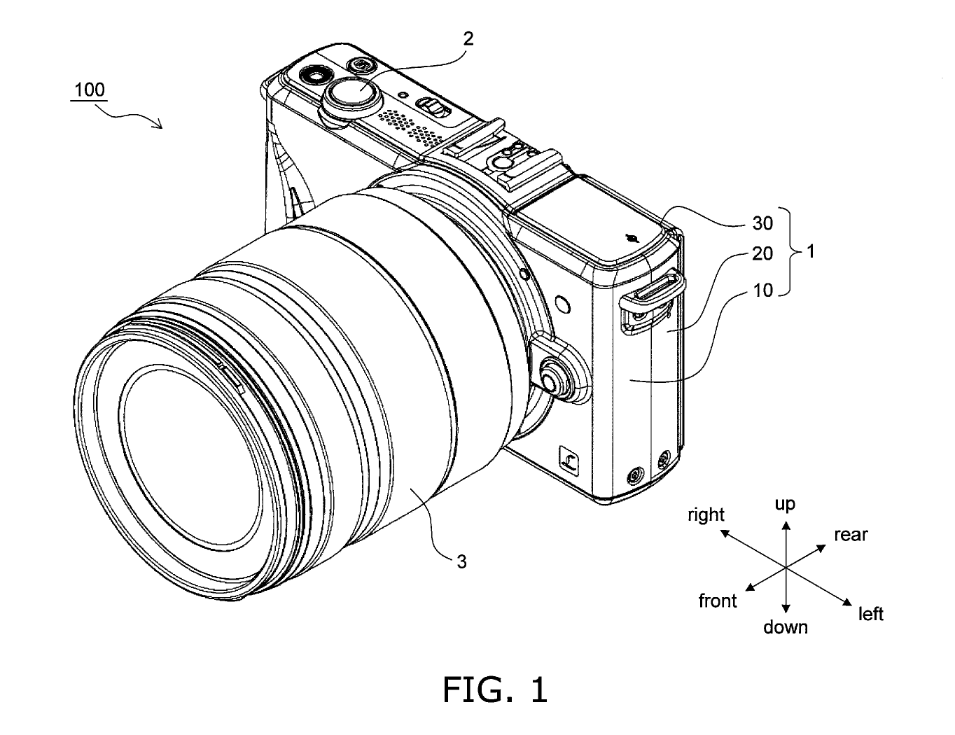

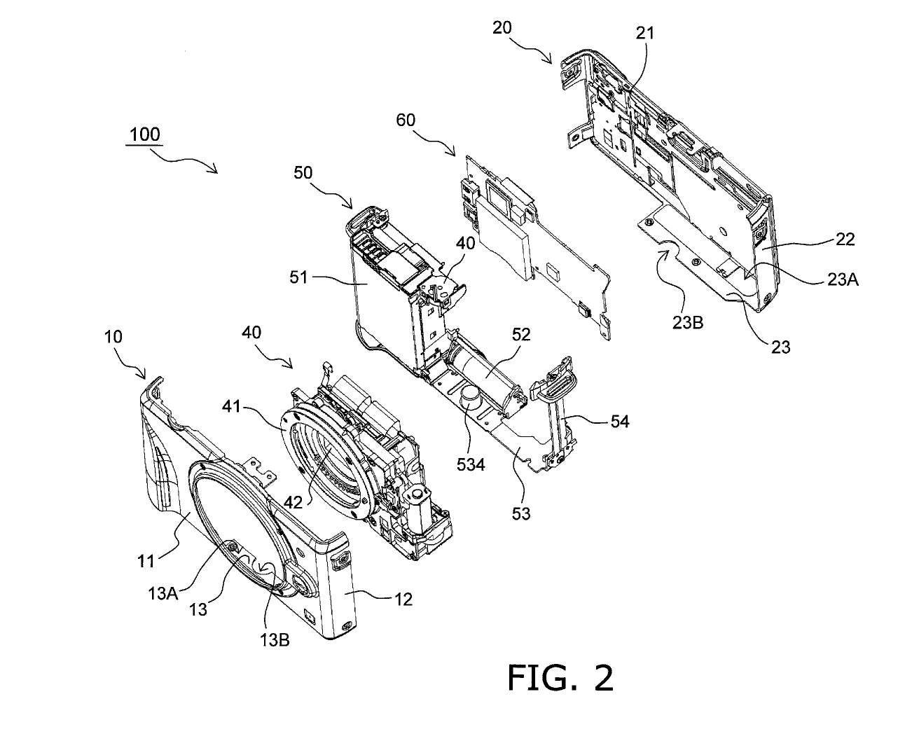

The overall configuration of the digital camera 100 pertaining to this embodiment will be described through reference to the drawings. FIG. 1 is an oblique view of the digital camera 100 pertaining to this embodiment. FIG. 2 is an exploded oblique view of the digital camera 100 pertaining to this embodiment.

As shown in FIGS. 1 and 2, the digital camera 100 comprises a housing 1, a shutter button 2, an interchangeable lens 3, a front cover 10, a rear cover 20, an upper cover 30, a mount unit 40, a battery unit 50, and a board unit 60.

The housing 1 is constituted by the front cover 10, the rear cover 20, and the upper cover 30. The housing 1 houses the mount unit 40, the battery unit 50, and the board unit 60 in a holding chamber formed in its interior.

The shutter button 2 receives an operation by the user to capture an image of a subject. The shutter button 2 is pressed down by the user.

The interchangeable lens 3 is attached to the mount unit 40. This makes it possible to exchange control signals (such as unique information about the interchangeable lens 3, or operational control information about the interchangeable lens 3) between the board unit 60 and the interchangeable lens 3.

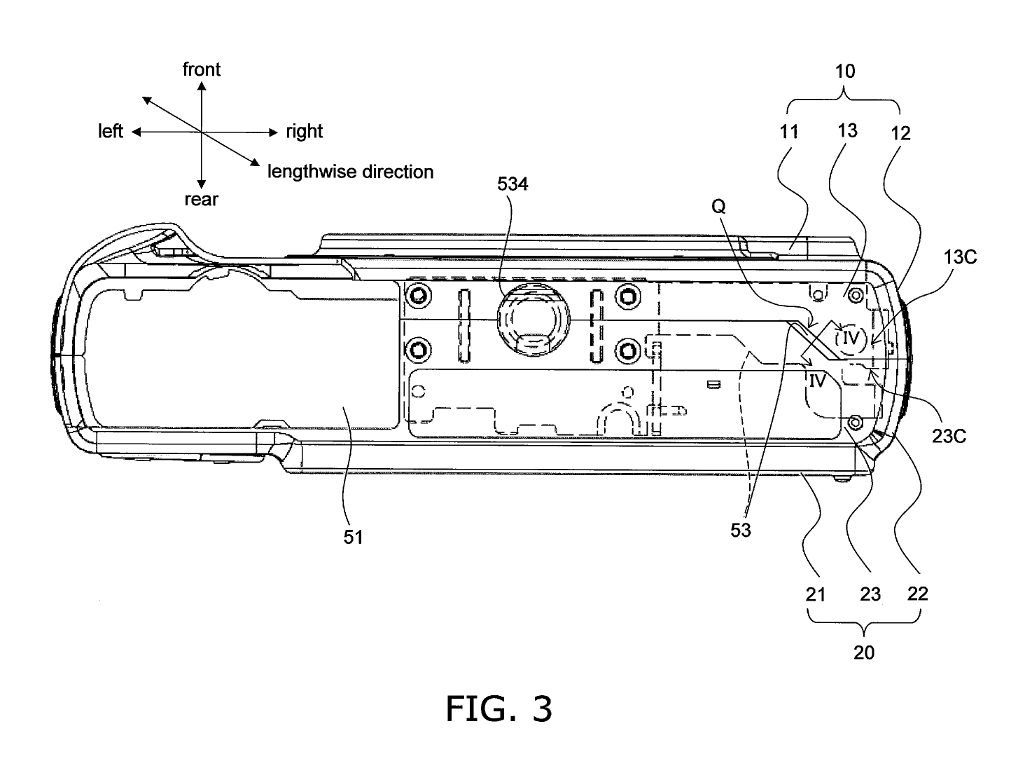

The front cover 10 has a front plate 11, a first side plate 12, and a first bottom plate 13. The front plate 11 is disposed in front of the battery unit 50. The first side plate 12 is grasped in the user's left hand during imaging. The first bottom plate 13 has a first inner face (or first inner surface) 13A and a first concave component 13B. The first inner face 13A forms the bottom face of the holding chamber formed in the interior of the housing 1. The first concave component 13B is a cut-out formed in a semicircular shape in plan view. The first concave component 13B is butted against a lower end of a leg seat 534 (discussed below; see FIG. 3).

The rear cover 20 has a rear plate 21, a second side plate 22, and a second bottom plate 23. The rear plate 21 is disposed to the rear of the battery unit 50. A liquid crystal panel (not shown) is attached to the rear plate 21. The second side plate 22 is grasped in the user's left hand during imaging. The second bottom plate 23 has a second inner face 23A (or second inner surface) and a second concave component 23B. The second inner face 23A is similar to the first inner face 13A in that it forms the bottom face of the holding chamber formed in the interior of the housing 1. The second concave component 23B is similar to the first concave component 13B in that it is a cut-out formed in a semicircular shape in plan view. The second concave component 23B is butted against the lower end of the leg seat 534 (see FIG. 3).

The upper cover 30 is fitted into the battery unit 50. The upper cover 30 is not shown in FIG. 2.

The mount unit 40 has a mount 41 and an imaging element 42. The mount 41 supports the interchangeable lens 3. The imaging element 42 receives light that has passed through the interchangeable lens 3 during imaging.

The battery unit 50 has a battery case 51, a capacitor 52, a first frame 53 (one example of a “built-in member”), and a second frame 54. The battery case 51 holds a battery (not shown). The capacitor 52 stores a charge for lighting a strobe (not shown). The second frame 54 is a flat member for fixing the first side plate 12 and the second side plate 22. The first frame 53 is a flat member and is built into the housing 1. The first frame 53 is also disposed along the first inner face 13A and the second inner face 23A.

The board unit 60 handles the main electrical processing in the digital camera 100.

FIG. 3 here is a bottom view of the digital camera 100 pertaining to this embodiment.

As shown in FIG. 3, the front cover 10 (more specifically, the first bottom plate 13) and the rear cover 20 (more specifically, the second bottom plate 23) are butted together so that the leg seat 534 is sandwiched from the front and rear. Accordingly, each of the first concave component 13B and the second concave component 23B must have a semicircular shape that corresponds to half the outer periphery of the leg seat 534 (see FIG. 2). For aesthetic requirement, it is preferable if the first side plate 12 and the second side plate 22 come into contact at positions equidistant from the front plate 11 and the rear plate 21, respectively. To satisfy these conditions, a protrusion 13C that protrudes to the rear in plan view is formed on the first bottom plate 13, and a recess 23C that is recessed to the rear in plan view is formed in the second bottom plate 23.

If there is machining variance in the protrusion 13C and the recess 23C, the protrusion 13C and the recess 23C will interfere with each other, so there will be a step between the first side plate 12 and the second side plate 22, which is aesthetically undesirable. Accordingly, with machining variance in mind, a gap Q is formed in advance between the first bottom plate 13 and the second bottom plate 23. The front cover 10 and the rear cover 20 are butted together so as to surround the gap Q. In this embodiment, the gap Q is formed along a lengthwise direction that intersects with a left-right direction and a front-rear direction of the digital camera 100.

Configuration of First Frame 53

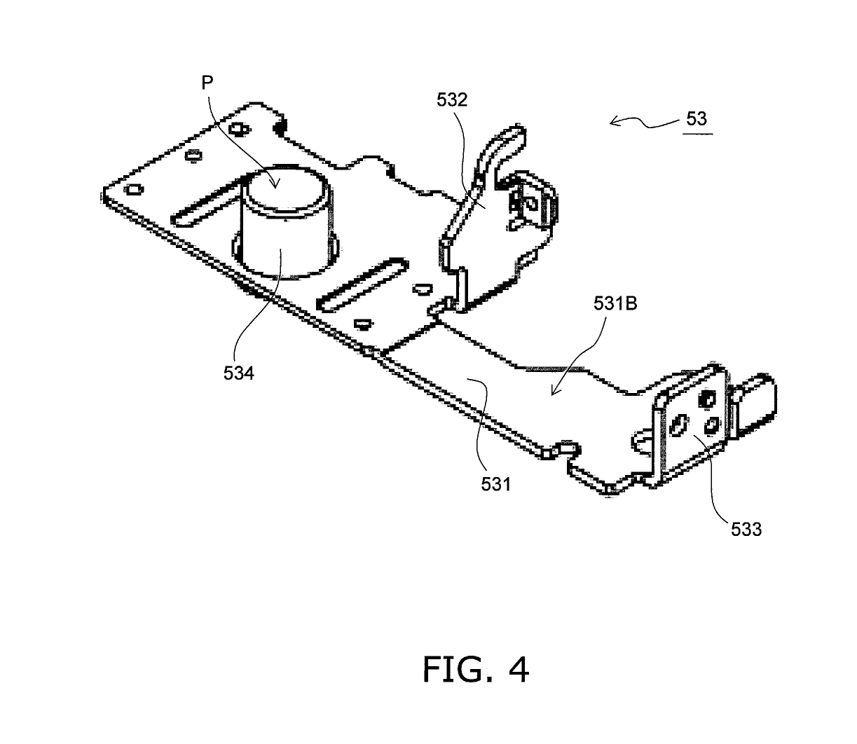

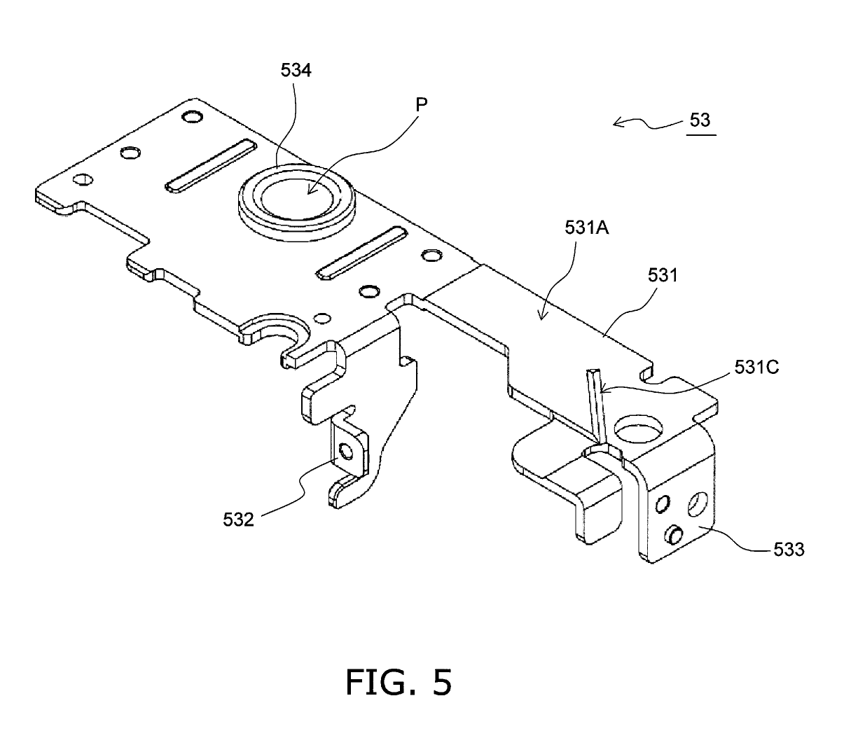

The configuration of the first frame 53 pertaining to this embodiment will be described through reference to the drawings. FIG. 4 is an oblique view of the first frame 53 as seen from the back face side. FIG. 5 is an oblique view of the first frame 53 as seen from the opposing face side. In the following discussion, we will assume that the first frame 53 is disposed in the housing 1.

The first frame 53 (an example of a “built-in member”) has a frame component 531, a capacitor attachment component 532, a second frame attachment component 533, and the leg seat 534.

The frame component 531 has an opposing face 531A, an back face 531B and a V-shaped groove 531C (one example of a “reflecting component”). The opposing face 531A is opposite the first inner face 13A and the second inner face 23A. The back face 531B is formed on the other side of the opposing face 531A. The V-shaped groove 531C is opposite the gap Q in the up-down direction. The V-shaped groove 531C is formed along the gap Q as seen in a direction perpendicular to the opposing face 531A. The V-shaped groove 531C is formed by working a recess in the frame component 531.

The capacitor attachment component 532 is the place where the capacitor 52 is fixed.

The second frame attachment component 533 is perpendicular to the frame component 531, and is connected to the second frame 54.

The leg seat 534 is a cylindrical member for mounting a leg member (not shown) that supports the housing 1. The leg seat 534 has an insertion hole P into which the leg member is inserted. The leg seat 534 is formed integrally with the first frame 53.

Positional Relation Between First Frame 53 and Gap Q

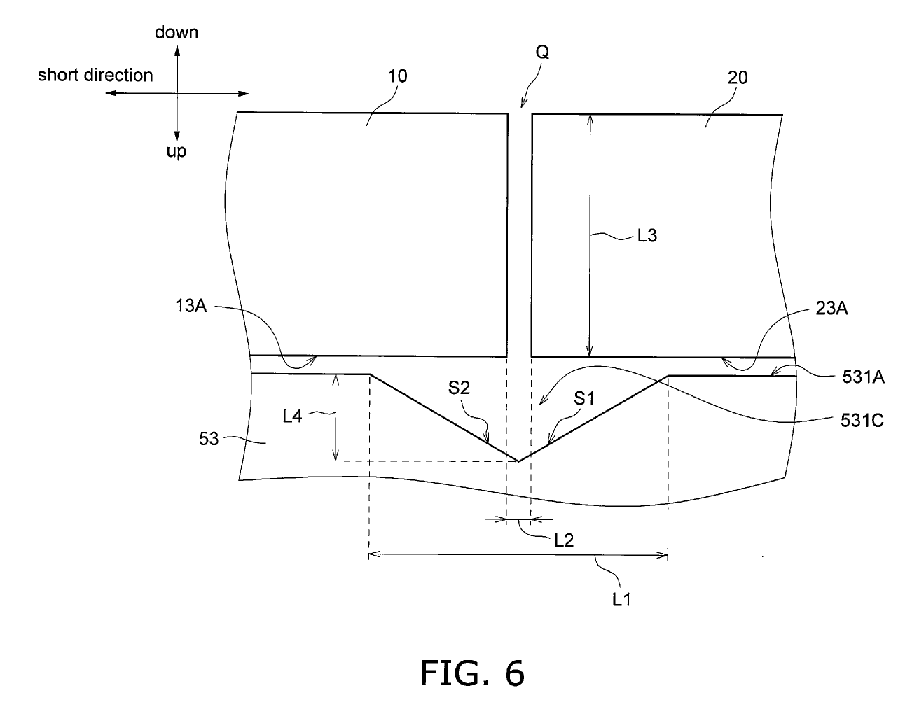

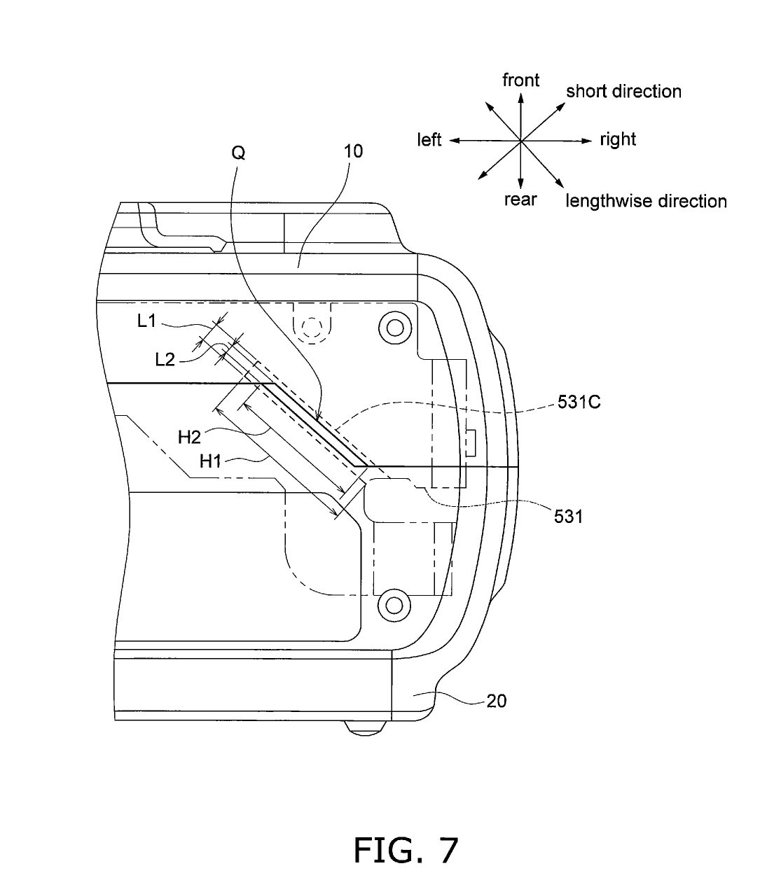

The positional relation between the first frame 53 and the gap Q pertaining to this embodiment will be described through reference to the drawings. FIG. 6 is a cross section along the A-A line in FIG. 3. FIG. 7 is a detail enlargement of FIG. 3.

As shown in FIG. 6, the first inner face 13A of the front cover 10 and the second inner face 23A of the rear cover 20 are linked in the same plane through the gap Q.

The V-shaped groove 531C has a first inclined face S1 and a second inclined face S2 (each an example of an “inclined face”). The V-shaped groove 531C reflects light coming in through the gap Q toward the interior of the housing 1. Specifically, the light that is incident on the first inclined face S1 and the second inclined face S2 is reflected toward the first inner face 13A and the second inner face 23A.

In this embodiment, taking into account the positional offset of the gap Q due to dimensional variance, a width L1 of the V-shaped groove 531C in a short direction of the gap Q (a direction perpendicular to the lengthwise direction of the gap Q) is greater than a width L2 of the gap Q in the short direction. The V-shaped groove 531C is overlapped in the up-down direction with the entire gap Q in a cross section that is along the short direction and is perpendicular to the opposing face 531A. Specifically, the V-shaped groove 531C is formed so as to cover the entire region of the gap Q in the short direction. The width L2 of the gap Q is less than a thickness L3 of the front cover 10 and the rear cover 20 in the up-down direction, and the width L1 of the V-shaped groove 531C is greater than a depth L4 of the V-shaped groove 531C in the up-down direction.

Also, as shown in FIG. 7, a length H1 of the V-shaped groove 531C in the lengthwise direction of the gap Q is greater than a length H2 of the gap Q. Also, the V-shaped groove 531C overlaps in the up-down direction with the entire gap Q in a cross section that is along the lengthwise direction and is perpendicular to the opposing face 531A. Specifically, the V-shaped groove 531C is formed so as to cover the entire region of the gap Q in the lengthwise direction.

Action and Effect

(1) With the digital camera 100 pertaining to this embodiment, the first frame 53 (an example of a “built-in member”) has the V-shaped groove 531C (an example of a “reflecting component”) having the first inclined face S1 and the second inclined face S2 (each an example of an “inclined face”) that are inclined with respect to the opposing face 531A and that are opposite the gap Q.

Accordingly, any light that comes into the interior of the housing 1 through the gap Q is reflected by the first inclined face S1 and the second inclined face S2, which reduces the amount of light that is emitted to the outside of the housing 1. Thus, light coming into the interior of the housing 1 through the gap Q is trapped inside the housing 1, which helps keep the first frame 53 from being visible through the gap Q from the outside, so the aesthetic quality of the digital camera 100 can be improved.

(2) The V-shaped groove 531C is recessed with respect to the opposing face 531A. Therefore, the V-shaped groove 531C can be formed simultaneously in producing the first frame 53 by stamping, so there is no increase in the number of manufacturing steps.

(3) The V-shaped groove 531C is formed along the gap Q as seen in a direction perpendicular to the opposing face 531A. Therefore, less light is emitted to the outside of the housing 1 than when the V-shaped groove 531C is formed so that it intersects the gap Q.

(4) The width L1 of the V-shaped groove 531C in the short direction of the gap Q is greater than the width L2 of the gap Q in the short direction. Therefore, less light is emitted to the outside of the housing 1 than when the width L1 of the V-shaped groove 531C is less than the width L2 of the gap Q.

(5) The V-shaped groove 531C is overlapped in the direction perpendicular to the opposing face 531A with the entire gap Q in a cross section that is along the short direction of the gap Q and is perpendicular to the opposing face 531A. Therefore, less light is emitted to the outside of the housing 1 than when only part of the V-shaped groove 531C is overlapped with the gap Q in the short direction.

(6) The length H1 of the V-shaped groove 531C in the lengthwise direction of the gap Q is greater than the length H2 of the gap Q in the lengthwise direction. Therefore, less light is emitted to the outside of the housing 1 than when the length H1 of the V-shaped groove 531C is less than the length H2 of the gap Q.

(7) The V-shaped groove 531C overlaps in a direction perpendicular to the opposing face 531A with the entire gap Q in a cross section that is along the lengthwise direction of the gap Q and is perpendicular to the opposing face 531A. Therefore, less light is emitted to the outside of the housing 1 than when only part of the V-shaped groove 531C is overlapped with the gap Q in the lengthwise direction.

(8) The first frame 53 has the leg seat 534 for mounting a leg member that supports the housing 1. Thus, the first frame 53 with its leg seat 534 must be strong enough to fix the leg member, so it is difficult to come up with a design that avoids the gap Q. Accordingly, since the first frame 53 is usually opposite the gap Q, the effect of the V-shaped groove 531C is more readily obtained if the V-shaped groove 531C is formed in this first frame 53.

(9) The first frame 53 is a flat frame disposed along the first inner face 13A and the second inner face 23A. This flat frame must be strong enough to maintain the shape of the housing 1, so it is difficult to come up with a design that avoids the gap Q. Accordingly, since the first frame 53 is usually opposite the gap Q, the effect of the V-shaped groove 531C is more readily obtained if the V-shaped groove 531C is formed in this first frame 53.

### Other Embodiments

The present invention is described by an embodiment above, but this should not be interpreted to mean that the text and drawings that form part of this disclosure limit this invention. Various substitute embodiments, working examples, and implementation techniques will probably be obvious to a person skilled in the art from this disclosure.

(A) In the above embodiment, the housing 1 is constituted by three covers: the front cover 10, the rear cover 20, and the upper cover 30, but is not limited to this. The housing 1 may be constituted by only two covers or by four or more.

(B) In the above embodiment, the gap Q is formed between the front cover 10 and the rear cover 20, but is not limited to this. The gap Q may be formed between the front cover 10 or the rear cover 20 and the upper cover 30.

(C) In the above embodiment, the V-shaped groove 531C is formed in the first frame 53, but is not limited to this. For example, if the battery case 51 is opposite the gap Q, the V-shaped groove 531C may be formed in the surface of the battery case 51. In this instance, the battery case 51 becomes the “built-in member.”

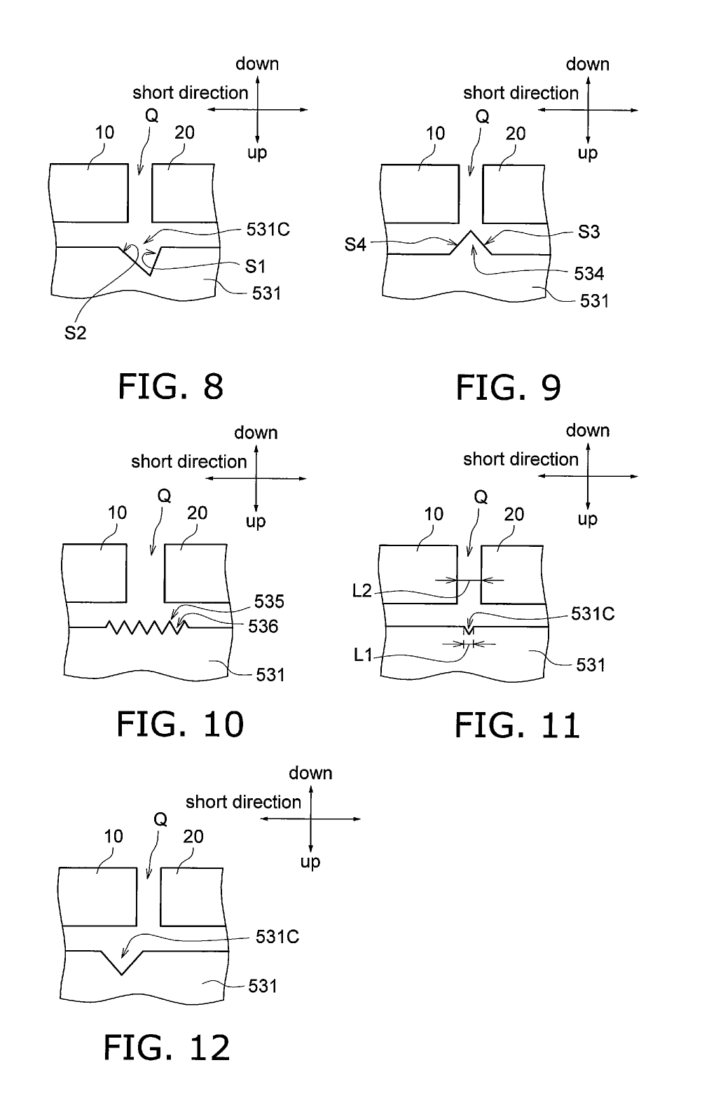

(D) In the above embodiment, the first inclined face S1 and the second inclined face S2 of the V-shaped groove 531C are formed symmetrical to each other in the short direction of the gap Q, but are not limited to this. For example, as shown in FIG. 8, the first inclined face S1 and the second inclined face S2 of the V-shaped groove 531C may be formed asymmetrical to each other in the short direction of the gap Q.

(E) In the above embodiment, the V-shaped groove 531C is described as an example of a “reflecting component,” but as shown in FIG. 9, a convex component 534 may be formed instead of the V-shaped groove 531C. The convex component 534 has a third inclined face S3 and a fourth inclined face S4 that are inclined with respect to the opposing face 531A.

(F) In the above embodiment, the V-shaped groove 531C is described as an example of a “reflecting component,” but as shown in FIG. 10, a plurality of convex components 535 and a plurality of concave components 536 may be formed instead of the V-shaped groove 531C. In this instance, the first inclined face S1 and the second inclined face S2 are formed by the convex components 535 and the concave components 536. Each of the convex components 535 and the concave components 536 may be formed continuously in the lengthwise direction of the gap Q, or may be formed intermittently in the lengthwise direction of the gap Q.

(G) In the above embodiment, the width L1 of the V-shaped groove 531C is greater than the width L2 of the gap Q, but is not limited to this. As shown in FIG. 11, the width L1 of the V-shaped groove 531C may be less than the width L2 of the gap Q.

(H) In the above embodiment, the V-shaped groove 531C overlaps with the entire gap Q in the up-down direction in a cross section along the short direction and perpendicular to the opposing face 531A, but is not limited to this. As shown in FIG. 12, the V-shaped groove 531C may overlap with only part of the gap Q in the up-down direction.

(I) In the above embodiment, the length H1 of the V-shaped groove 531C in the lengthwise direction of the gap Q is greater than the length H2 of the gap Q in the lengthwise direction, but is not limited to this. The length H1 of the V-shaped groove 531C may be less than the length H2 of the gap Q.

(J) In the above embodiment, the V-shaped groove 531C overlaps with the entire gap Q in the up-down direction in a cross section along the lengthwise direction and perpendicular to the opposing face 531A, but is not limited to this. As shown in FIG. 12, the V-shaped groove 531C may overlap with only part of the gap Q in a cross section along the lengthwise direction and perpendicular to the opposing face 531A.

(K) In the above embodiment, the first inclined face S1 and second inclined face S2 of the V-shaped groove 531C are formed in a planar shape, but are not limited to this. The first inclined face S1 and the second inclined face S2 may instead be formed as a curved surface, an undulating surface, etc.

(L) In the above embodiment, the V-shaped groove 531C has two “inclined faces,” namely, the first inclined face S1 and the second inclined face S2, but is not limited to this. The V-shaped groove 531C may have just one or may have three or more inclined faces.

(M) In the above embodiment, the gap Q is formed intentionally in order to absorb machining variance, but may instead be formed unintentionally by machining variance. In this instance, if the gap Q is formed over the entire boundary between the front cover 10 and the rear cover 20, the V-shaped groove 531C may be formed so as to correspond to the entire boundary between the front cover 10 and the rear cover 20.

(N) In the above embodiment, the digital camera 100 is described as an example of an “imaging device,” but other examples of an “imaging device” include a video camera and so on.

(O) In the above embodiment, the description is of a case in which a “housing structure,” with which light coming into the interior of the housing 1 through the gap Q could be trapped inside the housing 1, is applied to an “imaging device,” but this “housing structure” is not limited to an “imaging device,” and can be applied to any of various “electronic devices,” such as television sets, DVD recorders, IC recorders, and so forth.

Thus, the present invention of course includes various embodiments and the like that are not discussed herein. Therefore, the technological scope of the present invention is not limited to just the specific inventions pertaining to the appropriate claims from the descriptions given above.

### GENERAL INTERPRETATION OF TERMS

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a housing structure and an imaging device. Accordingly, these terms, as utilized to describe the present invention should be interpreted relative to a housing structure and an imaging device.

The term “configured” as used herein to describe a component, section, or part of a device implies the existence of other unclaimed or unmentioned components, sections, members or parts of the device to carry out a desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A housing structure comprising:
a housing including a first cover having a first inner surface and a second cover having a second inner surface, the first cover abutting the second cover and defining a gap through which the first inner surface is configured to communicate with the second inner surface; and
a built-in member formed in the housing, the built-in member including an opposing surface and a reflecting component, the opposing surface being disposed opposite to the first inner surface and the second inner surface, and the reflecting component having an inclined surface facing the gap, the inclined surface being disposed at an angle relative to the opposing surface.

2. The housing structure according to claim 1, wherein
the reflecting component is a concave surface recessed in the a built-in member relative to the opposing surface.

3. The housing structure according to claim 1, wherein
the reflecting component is a concave surface protruding from the a built-in member relative to the opposing surface.

4. The housing structure according to claim 2, wherein
the reflecting component is formed along the gap when viewed from a direction perpendicular to the opposing surface.

5. The housing structure according to claim 4, wherein
the width of the reflecting component a short direction of the gap is greater than the width of the gap in the short direction.

6. The housing structure according to claim 5, wherein
the reflecting component overlaps the entire width of the gap in a direction perpendicular to the opposing surface.

7. The housing structure according to claim 1, wherein
the length of the reflecting component in a lengthwise direction of the gap is greater than the length of the gap in the lengthwise direction.

8. The housing structure according to claim 7, wherein
the reflecting component overlaps the entire length of the gap in a direction perpendicular to the opposing face.

9. The housing structure according to claim 1, wherein
the built-in member further includes a leg seat configured to be mount to a leg member to support the housing.

10. The housing structure according to claim 9, wherein
the built-in member is a flat frame disposed along the first inner surface and the second inner surface.

11. An imaging device comprising:
the housing structure according to claim 1; and
an imaging element disposed in the housing configured to convert light into an electrical signal.
